(19) United States
(12) Patent Application Publication
(10) Pub. No.: US 2015/0266682 A1
(43) Pub. Date: Sep. 24, 2015

(54) IMAGE FORMING APPARATUS

(71) Applicant: Funai Electric Co., Ltd., Osaka (JP)

(72) Inventors: Masaaki TAKAGI, Kashihara-shi (JP); Yohei EMI, Shiso-shi (JP)

(21) Appl. No.: 14/661,185

(22) Filed: Mar. 18, 2015

(30) Foreign Application Priority Data
Mar. 18, 2014 (JP) 2014-055044

(51) Int. Cl. B65H 5/06; B65H 7/20; F16H 7/08

(52) U.S. Cl. CPC B65H 5/064; F16H 7/08; B65H 7/20

(57) ABSTRACT

An image forming apparatus includes a printer, a lower feeding roller that feeds a sheet, a bearing that rotatably supports the lower feeding roller with respect to a housing, a belt rotating mechanism including a belt disposed over the lower feeding roller and driving the lower feeding roller, and a leaf spring that biases the lower feeding roller in a direction opposite to the direction of deformation of the feeding roller caused by the tension of the belt. The belt is arranged on the outer side in the axial direction of the lower feeding roller with respect to the bearing. The leaf spring is arranged on the outer side in the axial direction of the lower feeding roller with respect to the belt, so that the leaf spring biases the lower feeding roller.

### BACKGROUND OF THE INVENTION

1. Field of the Invention

The present invention relates to an image forming apparatus, and particularly to an image forming apparatus including a belt.

2. Description of the Related Art

An image forming apparatus including a belt is known in the related art, as disclosed in JP 2006-349883 A.

JP 2006-349883 A discloses an image forming apparatus including a printing unit, a feeding roller to feed a sheet, a belt disposed across substantially the whole area in the axial direction of the feeding roller, and a belt stretching roller that rotates with the feeding roller after the belt is arranged and a driving force is applied to the feeding roller. The above image forming apparatus also includes a deflection prevention member configured to control deflection of the feeding roller and the belt stretching roller caused by the tension of the belt. The deflection prevention member is arranged at the substantially central position in the axial direction of the feeding roller and the belt stretching roller, and between and in contact with both the feeding roller and the belt stretching roller.

In JP 2006-349883 A, the deflection prevention member is not disposed over the entire area in the axial direction, but is only disposed at the substantially central position in the axial direction of the feeding roller and the belt stretching roller. Disadvantageously, therefore, deflection occurs in the feeding roller at an area where no deflection prevention member is arranged. Thus, the deflection prevention member described in JP 2006-349883 A is considered to be insufficient for satisfactorily suppressing the deformation of the feeding roller. Therefore, using this member may deteriorate sheet feeding accuracy of the feeding roller.

### SUMMARY OF THE INVENTION

Preferred embodiments of the present invention provide an image forming apparatus capable of further suppressing deterioration of sheet feeding accuracy by satisfactorily reducing or preventing deformation of the feeding roller.

According to one aspect of various preferred embodiments of the present invention, an image forming apparatus includes a printing unit; a feeding roller configured to feed a sheet; a bearing configured to rotatably support the feeding roller with respect to a housing; a belt rotating mechanism including a belt that is disposed over the feeding roller and drives the feeding roller; and a biasing member configured to bias the feeding roller in a direction opposite to a direction of deformation of the feeding roller caused by a tension of the belt, wherein the belt is arranged on an outer side in the axial direction of the feeding roller with respect to the bearing, and the biasing member is arranged on the outer side in the axial direction of the feeding roller with respect to the belt, so as to bias the feeding roller.

In one aspect of various preferred embodiments of the present invention, the image forming apparatus includes the biasing member configured to bias the feeding roller in a direction opposite to the direction of deformation of the feeding roller caused by the tension of the belt. The biasing member biases the feeding roller in the direction opposite to the direction of the deformation of the feeding roller caused by the tension of the belt. The belt is arranged on the outer side in the axial direction of the feeding roller with respect to the bearing. The biasing member is also arranged on the outer side in the axial direction of the feeding roller. With this configuration, a moment from the belt, and a first moment from the biasing member acting in a direction opposite to a second moment from the belt, are applied to a location where the feeding roller abuts the bearing. As a result, the first and second moments acting in the opposite directions cancel each other, making it possible to further reduce or prevent the deformation and deflection of the feeding roller. Consequently, it is possible to further reduce or prevent deterioration of sheet feeding accuracy. Furthermore, a distance between the biasing member and the bearing is longer than a distance between the belt and the bearing, enabling a large moment to be applied to the feeding roller with less force than the force applied to the feeding roller by the belt.

The image forming apparatus preferably further includes a tension applying member including a rotatable member that presses the belt and is rotatable together with movement of the belt, the tension applying member being configured to apply tension to the belt, wherein the biasing member is configured to bias the feeding roller in a direction opposite to a direction of deformation of the feeding roller caused by the tension applied to the belt by the tension applying member. This configuration stabilizes the belt conditions using the tension applying member. Furthermore, a first moment applied by the belt, to which the tension has been added by the tension applying member, and a second moment applied to the feeding roller by the biasing member cancel each other. Thus, it is possible to further effectively reduce or prevent the deformation (deflection) of the feeding roller. As a result, it is possible to further reduce or prevent the deterioration of sheet feeding accuracy.

The feeding roller is preferably made of resin and integrally includes a roller configured to abut the sheet, and a shaft provided at each end of the roller and biased by the biasing member. In the case of a feeding roller made of resin, which is easily deformed, using the biasing member according to a preferred embodiment of the present invention is particularly effective to reduce or prevent the deformation of the feeding roller caused by the belt.

The belt rotating mechanism preferably includes a sheet supply roller configured to supply a sheet from the upstream of the feeding roller, the belt being disposed across the sheet supply roller and the feeding roller, the sheet supply roller is preferably made of metal and has a larger diameter than the feeding roller, and the biasing member is configured to bias the feeding roller without biasing the sheet supply roller. With this configuration, the sheet supply roller is made of metal with the diameter larger than that of the feeding roller, and thus achieves a higher rigidity than the feeding roller. Therefore, biasing the feeding roller with the biasing member will not cause deformation of the sheet supply roller. Accordingly, biasing the feeding roller significantly reduces or prevents deformation of both the sheet supply roller and the feeding roller across which the belt is disposed. Thus, there is no need to bias both of the sheet supply roller and the feeding roller.

The biasing member preferably includes one of a leaf spring and a coil spring. With this configuration, the simply configured leaf spring or coil spring easily biases the feeding roller.

The biasing member preferably includes a wire spring. With this configuration, the simply configured wire spring easily biases the feeding roller. Furthermore, the wire spring and the feeding roller are in point contact or substantially in point contact with each other, and significantly reduce or prevent deformation of the feeding roller with a low frictional force. Therefore, it is possible to significantly reduce or prevent an increase in the force required to drive the feeding roller caused by the frictional force of the biasing member.

Accordingly, various preferred embodiments of the present invention sufficiently reduce or prevent deformation of the feeding roller, and thus further reduce or prevent deterioration of sheet feeding accuracy.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view showing how an inkjet printer is used according to a first preferred embodiment of the present invention.

FIG. 2 is a perspective view showing a main body of the inkjet printer according to the first preferred embodiment of the present invention.

FIG. 3 is a perspective view showing the configuration near a belt including a leaf spring of the inkjet printer according to the first preferred embodiment of the present invention.

FIG. 4 is a schematic diagram showing the configuration of the inkjet printer according to the first preferred embodiment of the present invention.

FIG. 5 is a plan view showing the configuration near a feed-side pulley of the inkjet printer according to the first preferred embodiment of the present invention.

FIG. 6 is a perspective view showing the configuration near a belt including a wire spring of an inkjet printer according to a second preferred embodiment of the present invention.

FIG. 7 is a perspective view showing the configuration near a belt including an extension coil spring of an inkjet printer according to a third preferred embodiment of the present invention.

### DETAILED DESCRIPTION OF THE PREFERRED EMBODIMENTS

Hereinafter, preferred embodiments of the present invention will be described with reference to the attached drawings.

### First Preferred Embodiment

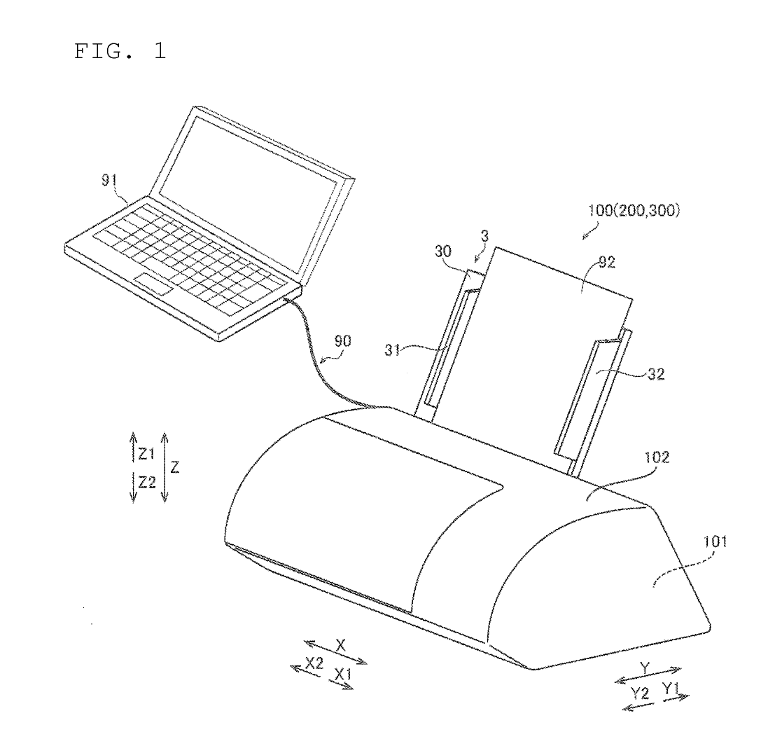

A configuration of an inkjet printer 100 according to a first preferred embodiment of the present invention will be described with reference to FIGS. 1 to 5. The inkjet printer 100 is an example of an “image forming apparatus” according to a preferred embodiment of the present invention.

As shown in FIG. 1, the inkjet printer 100 includes a main body 101 and a cover 102 that covers the main body 101.

The inkjet printer 100 is connected, for example, to a personal computer (PC) 91 via a USB cable 90, but can also be connected wirelessly. The inkjet printer 100 is configured to operate in response to user operations on the PC 91 connected to the inkjet printer 100. In use, the inkjet printer 100 is placed so that a front side (Y2 direction side) thereof faces the user. Here, the “front side” in the present preferred embodiment represents a side facing the user of the inkjet printer 100 during normal use.

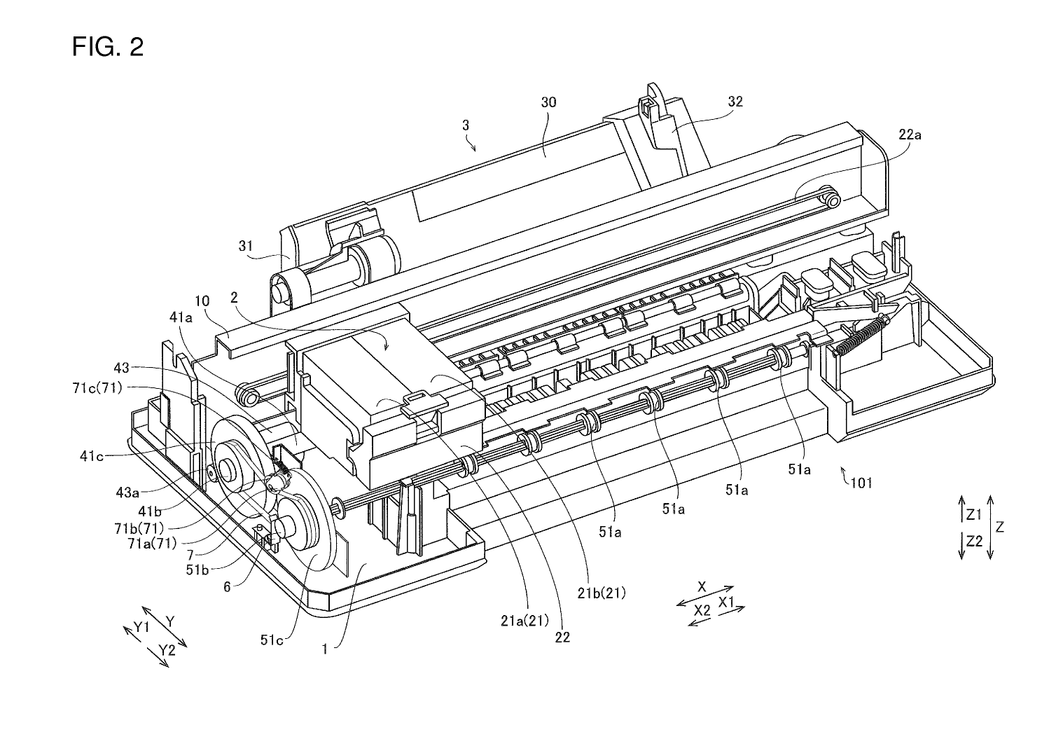

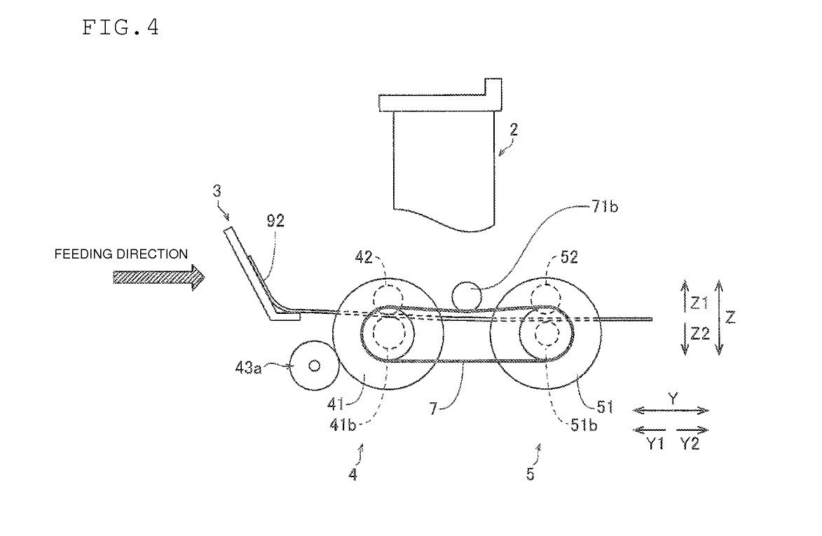

As shown in FIG. 2, the main body 101 of the inkjet printer 100 includes a housing 1, a printing unit 2, a sheet positioning unit 3, a sheet supply roller unit 4 (see FIG. 4), a feeding roller unit 5 (see FIG. 4), and a leaf spring 6. The inkjet printer 100, as shown in FIG. 2, further includes a guide unit 10 configured to guide the movement of the printing unit 2 (a carriage 22 to be described later). The guide unit 10, disposed upstream (Y1 direction side) of the printing unit 2, extends in a vertical or substantially vertical (perpendicular or substantially perpendicular to horizontal) direction (Z direction) from the housing 1. Hereafter, the direction from the back side to the front side (from the Y1 direction to the Y2 direction) of the inkjet printer 100 will be referred to as a feeding direction of a sheet 92.

The printing unit 2 is configured to print on the sheet 92. The printing unit 2 includes an ink cartridge 21 and the carriage 22 on which the ink cartridge 21 is mounted. The ink cartridge 21 includes an ink cartridge 21a for a black ink, and an ink cartridge 21b for inks of a plurality of different colors such as cyan, magenta, and yellow. The carriage 22 is attached to the guide unit 10 of the housing 1 via a first belt 22a such that the carriage 22 is movable in the left-right direction (X direction).

As shown in FIG. 1, the sheet positioning unit 3 is mounted on the back surface side (Y1 direction side) of the inkjet printer 100. The sheet positioning unit 3 includes a sheet placement unit 30, which preferably is rectangular or substantially rectangular, a left end portion 31, and a right end portion 32. The sheet positioning unit 3 is configured to enable the left end portion 31 to move in the left-right direction (X direction), which is perpendicular or substantially perpendicular to the feeding direction of the sheet 92, as viewed from the front side. The right end portion 32 is configured not to move with respect to the sheet placement unit 30.

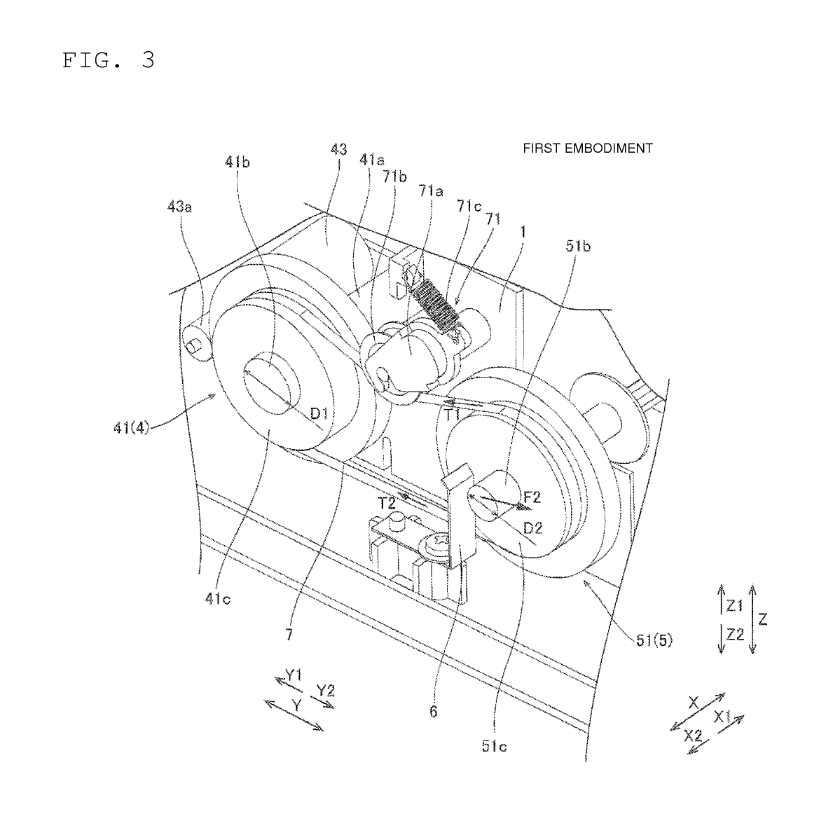

As shown in FIG. 4, the sheet supply roller unit 4 and the feeding roller unit 5 are configured to work together to feed the sheet 92 positioned by the sheet positioning unit 3. The sheet supply roller unit 4 and the feeding roller unit 5 are connected to each other via a second belt 7, which will be described later. The inkjet printer 100 (see FIG. 1) further includes a motor 43 to supply a driving force to the sheet supply roller unit 4. With this configuration, when the motor 43 (see FIGS. 2 and 3) is driven, the sheet supply roller unit 4 and the feeding roller unit 5 are also driven together to feed the sheet 92. The second belt 7 is an example of a “belt” according to a preferred embodiment of the present invention.

The second belt 7, disposed across the sheet supply roller unit 4 and the feeding roller unit 5, transmits the driving force from the sheet supply roller unit 4 to the feeding roller unit 5. Specifically, the second belt 7 is disposed across a sheet supply-side pulley 41c of the sheet supply roller unit 4 and a feed-side pulley 51c of the feeding roller unit 5. The sheet supply-side pulley 41c and the feed-side pulley 51c will be described later. As shown in FIG. 3, a tension applying member 71 is disposed above the second belt 7 (in Z1 direction) so as to give tension to the second belt 7. Although not shown, the second belt 7 is a toothed belt, and the sheet supply-side pulley 41c and the feed-side pulley 51c are toothed pulleys.

The tension applying member 71 includes a supporting unit 71a rotatably attached to the housing 1, a rotating unit 71b supported by the supporting unit 71a, and a coil spring 71c configured to apply a rotational moment to the supporting unit 71a. The supporting unit 71a, with the rotating unit 71b located at one end and the coil spring 71c located at the other end, is attached to the housing 1 between the rotating unit 71b and the coil spring 71c. The rotating unit 71b, while pressing the second belt 7 from the upper direction (Z1 direction), rotates itself together with the movement of the second belt 7. With this configuration, tension is applied to the second belt 7.

As shown in FIG. 4, the sheet supply roller unit 4 is arranged upstream (Y1 direction side) of the central portion of the printing unit 2 (the carriage 22), as viewed in the axial direction (X direction). The sheet supply roller unit 4 includes a lower sheet supply roller 41 and an upper sheet supply roller 42. The lower sheet supply roller 41 is an example of a “sheet supply roller” according to a preferred embodiment of the present invention.

As shown in FIG. 3, the lower sheet supply roller 41, extending in the left-right direction (X direction), includes a roller unit 41a, which abuts the sheet 92, a shaft unit 41b at each end of the roller unit 41a (only the one on the X2 direction side is shown), and the sheet supply-side pulley 41c fixed near the left end portion (the end portion in the X2 direction) on the shaft unit 41b. The shaft unit 41b is configured to be rotatably supported by the housing 1 via a bearing (not shown).

The roller unit 41a of the lower sheet supply roller 41 and the upper sheet supply roller 42 (see FIG. 4) face each other in the vertical or substantially vertical direction (Z direction).

The lower sheet supply roller 41, which is preferably made of metal such as iron, is configured so that a diameter D1 (of a portion where the second belt 7 is disposed) becomes larger than a diameter D2 of a lower feeding roller 51 (a shaft unit 51b), described later. That is, the lower sheet supply roller 41 has a higher rigidity than the lower feeding roller 51, so as not to be deformed (deflected) by an external force.

The sheet supply-side pulley 41c is configured to abut a gear 43a, mounted at an end of the rotating shaft of the motor 43. With this configuration, the sheet supply roller unit 4 obtains a driving force from the motor 43. Consequently, the sheet supply roller unit 4 is configured to supply (feed) the sheet 92 from upstream (Y1 direction side) of the feeding roller, while the sheet 92 is sandwiched between the lower sheet supply roller 41 and the upper sheet supply roller 42 (see FIG. 4).

The sheet supply roller unit 4 is configured to transmit the driving force obtained from the motor 43 via the second belt 7, to the feeding roller unit 5. In the lower sheet supply roller 41, an encoder (not shown) is provided to detect the amount of rotation of the lower sheet supply roller 41 (amount corresponding to the feeding amount of the sheet 92).

As shown in FIG. 4, the feeding roller unit 5 is arranged downstream (Y2 direction side) of the central portion of the printing unit 2 (the carriage 22), as viewed in the axial direction (X direction). The feeding roller unit 5 includes the lower feeding roller 51 and an upper feeding roller 52. The lower feeding roller 51 is an example of a “feeding roller” according to a preferred embodiment of the present invention.

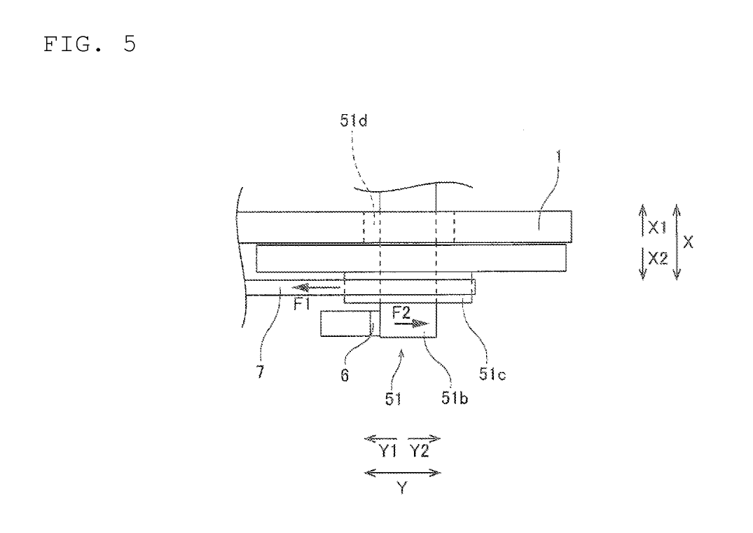

As shown in FIG. 3, the lower feeding roller 51 extends in the left-right direction (X direction) and integrally includes a roller unit 51a, which abuts the sheet 92, and the shaft unit 51b (only the one on the X2 direction side is shown) at each end of the roller unit 51a. The lower feeding roller 51 includes the feed-side pulley 51c which is fixed near the left end portion (end in the X2 direction), on the shaft unit 51b. As shown in FIG. 5, the shaft unit 51b is configured to be rotatably supported by the housing 1 via a bearing 51d.

As shown in FIG. 4, the roller unit 51a of the lower feeding roller 51 and the upper feeding roller 52 are arranged to face each other in the vertical or substantially vertical direction (Z direction). The lower feeding roller 51 and the upper feeding roller 52 are preferably made of resin, for example.

In the first preferred embodiment, as shown in FIG. 5, the inkjet printer 100 (see FIG. 1) is arranged so that the second belt 7 is located on the outer side (X1 direction) of the lower feeding roller 51 in the axial direction (X direction) with respect to the bearing 51d. On the feed-side pulley 51c of the lower feeding roller 51, the second belt 7 is disposed from the side of the lower sheet supply roller 41 (Y1 direction) (see FIG. 3). With this configuration, a force to deform the lower feeding roller 51 in the Y1 direction is applied to the lower feeding roller 51. More specifically, as shown in FIG. 3, the tension applying member 71 (see FIG. 3) presses the second belt 7 from the upper direction (Z2 direction). Thus, the lower feeding roller 51 receives a combined force F1 (the sum of a tension T1 and a tension T2) (see FIG. 3) that deforms the lower feeding roller 51 in the direction (Z1 direction), which is slightly more downward than the Y1 direction (diagonally downward direction).

The force F1 that deforms the lower feeding roller 51 is generated by the second belt 7. Thus, as shown in FIG. 5, a resultant moment from the second belt 7 with the bearing 51d as a fulcrum is applied clockwise, as viewed from the Z1 direction, to the lower feeding roller 51.

In the first preferred embodiment, the leaf spring 6 is arranged in the inkjet printer 100 (see FIG. 1). Specifically, the leaf spring 6 is arranged on the outer side (X1 direction) in the axial direction (X direction) of the shaft unit 51b of the lower feeding roller 51, with respect to the second belt 7.

The leaf spring 6 is configured to bias, with the force F2, the end portion of the shaft unit 51b of the lower feeding roller 51 in a direction opposite to the deforming direction (diagonally downward direction stated above) of the lower feeding roller 51, the deformation being caused by the tension from the second belt 7. Specifically, the leaf spring 6 preferably has an L-shaped or substantially L-shaped configuration including two flat plate portions. One of the flat plate portions of the leaf spring 6 is fixedly attached to the housing 1 at the lower side (Z2 direction side). The other flat plate portion is configured to abut the vicinity of the end of the shaft unit 51b on the X2 direction side of the lower feeding roller 51 while being elastically deformed. That is, the other flat plate portion is configured to abut the shaft unit 51b of the lower feeding roller 51 while being elastically deformed from the Y1 direction.

The force F2 that biases the lower feeding roller 51 is generated by the leaf spring 6. Thus, as shown in FIG. 5, a resultant moment from the leaf spring 6 with the bearing 51d as a fulcrum is applied counterclockwise, as viewed from the Z1 direction, to the lower feeding roller 51.

With this configuration, the moment caused by the second belt 7 and the moment caused by the leaf spring 6 act in the opposite directions, so as to cancel each other. As a result, the leaf spring 6 suppresses the deformation of the lower feeding roller 51 caused by the second belt 7. Preferably, the moment caused by the force F2 that is generated by the leaf spring 6 and biases the lower feeding roller 51 is the same or substantially the same as the moment caused by the force F1 that is generated by the second belt 7 and deforms the lower feeding roller 51. That is, the force F2 is preferably set large enough to suppress or prevent the deformation of the shaft unit 51b caused by the force F1.

The following effects are achieved in the first preferred embodiment of the present invention.

The first preferred embodiment above includes the leaf spring 6 configured to bias the lower feeding roller 51 in a direction opposite to the direction of deformation of the lower feeding roller 51 caused by the tension of the second belt 7. The leaf spring 6 biases the lower feeding roller 51 in the direction opposite to the direction of the deformation of the lower feeding roller 51 caused by the tension of the second belt 7. The lower feeding roller 51 is disposed on the outer side in the axial direction (X direction) of the lower feeding roller 51 with respect to the bearing 51d. At the same time, the leaf spring 6 is disposed on the outer side in the axial direction (X2 direction side) of the lower feeding roller 51. With this configuration of the lower feeding roller 51 and the leaf spring 6, arranged so that the leaf spring 6 biases the lower feeding roller 51, as described above, a moment generated by the second belt 7 and a moment generated by the leaf spring 6 are applied to a location where the lower feeding roller 51 abuts the bearing 51d, the moments acting in the directions opposite to each other. Thus, the moments acting in the opposite directions cancel each other, making it possible to further suppress the deformation (deflection) of the lower feeding roller 51. As a result, the deterioration of sheet feeding accuracy for the sheet 92 is further suppressed. In addition, the distance between the leaf spring 6 and the bearing 51d is longer than the distance between the second belt 7 and the bearing 51d. This configuration enables a larger moment to be applied to the lower feeding roller 51, with less force F2 than the force F1 applied by the second belt 7 to the lower feeding roller 51.

The first preferred embodiment includes the rotating unit 71b that rotates with the moving second belt 7 while pressing the second belt 7, and the tension applying member 71 that applies tension to the second belt 7. Here, the leaf spring 6 preferably is configured to bias the lower feeding roller 51 in a direction opposite to the direction of deformation of the lower feeding roller 51 caused by the tension applied to the second belt 7 by the tension applying member 71. This configuration stabilizes the second belt 7 using the tension applying member 71. This configuration also has a canceling effect using the following moments: one moment coming from the second belt 7 to which the tension has been applied by the tension applying member 71, and another moment applied to the lower feeding roller 51 by the leaf spring 6. The moments cancel each other, making it possible to more effectively suppress or prevent the deformation (deflection) of the lower feeding roller 51. As a result, it is possible to further reduce or prevent the deterioration of sheet feeding accuracy for the sheet 92.

In the first preferred embodiment, as described above, the lower feeding roller 51, preferably made of resin, is configured to integrally include the roller unit 51a, which abuts the sheet 92, and the shaft unit 51b provided at each end of the roller unit 51a and biased by the leaf spring 6. In the case of the lower feeding roller 51 preferably made of resin, which is easily deformed, using the leaf spring 6 according to a preferred embodiment of the present invention is particularly effective to suppress or prevent the deformation of the lower feeding roller 51 caused by the second belt 7.

In the first preferred embodiment, as described above, the lower sheet supply roller 41 is preferably made of metal and larger in diameter than the lower feeding roller 51. The leaf spring 6 is configured to bias the lower feeding roller 51 without biasing the lower sheet supply roller 41. The lower sheet supply roller 41, thus configured to be made of metal with a larger diameter than the lower feeding roller 51, achieves a higher rigidity than the lower feeding roller 51. Accordingly, biasing the lower feeding roller 51 using the leaf spring 6 will not cause deformation of the lower sheet supply roller 41. Accordingly, biasing the lower feeding roller 51 suppresses or prevents deformation of both the lower sheet supply roller 41 and the lower feeding roller 51 across which the second belt 7 is disposed. That is, there is no need to bias both of the lower sheet supply roller 41 and the lower feeding roller 51.

In the first preferred embodiment, the leaf spring 6 preferably is a biasing member that biases the lower feeding roller 51 as described above. As a result, the simply configured leaf spring 6 easily biases the lower feeding roller 51.

### Second Preferred Embodiment

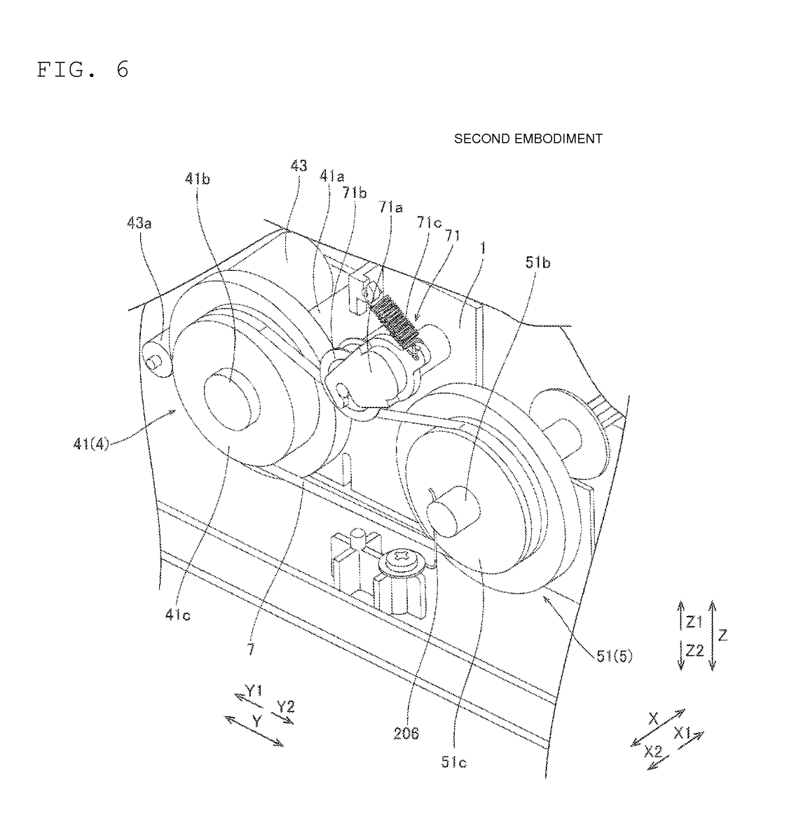

A configuration of an inkjet printer 200 according to a second preferred embodiment of the present invention will be described with reference to FIGS. 1 and 6. The second preferred embodiment describes an example of biasing a lower feeding roller 51 using a wire spring 206, unlike the first preferred embodiment that uses the leaf spring 6 to bias the lower feeding roller 51. The inkjet printer 200 is an example of an “image forming apparatus” according to a preferred embodiment of the present invention. The wire spring 206 is an example of a “biasing member” according to a preferred embodiment of the present invention. For a similar configuration to the first preferred embodiment, description will be omitted by using the same reference signs as in the first preferred embodiment, attached to the figures.

As shown in FIG. 6, the inkjet printer 200 (see FIG. 1) according to the second preferred embodiment includes the wire spring 206.

The wire spring 206 is fixedly attached to the housing and extends upward (Z1 direction). The wire spring 206 is arranged so as to abut a shaft unit 51b of the lower feeding roller 51 in the vicinity of the upper end of the spring (Z1 direction). The wire spring 206 is arranged so as to abut the shaft unit 51b of the lower feeding roller 51 from the Y1 direction side. The wire spring 206 is further configured to abut, while being elastically deformed, the vicinity of the end of the shaft unit 51b on the X2 direction side of the lower feeding roller 51.

Thus, with the force that is generated by the wire spring 206 and biases the lower feeding roller 51, a resultant moment generated by the wire spring 206 with a bearing 51d as a fulcrum is applied to the lower feeding roller 51 counterclockwise as viewed from the Z1 direction.

The end of the shaft unit 51b preferably has a round-shaft shape. Accordingly, the wire spring 206 and the shaft unit 51b abut each other in point contact or substantially in point contact.

The second preferred embodiment shares the same configuration as in the first preferred embodiment for the elements and configurations not specified above.

The following effects are achieved in the second preferred embodiment of the present invention.

In a manner similar to the first preferred embodiment, the second preferred embodiment includes the wire spring 206 to bias the lower feeding roller 51 in a direction opposite to the direction of deformation of the lower feeding roller 51 caused by the tension of a second belt 7. The wire spring 206 biases the lower feeding roller 51 in the direction opposite to the direction of the deformation of the lower feeding roller 51 caused by the tension of the second belt 7. The lower feeding roller 51 is disposed on the outer side in the axial (X) direction of the lower feeding roller 51 with respect to the bearing 51d. The wire spring 206 that biases the lower feeding roller 51 is arranged on the outer side in the axial (X2) direction of the lower feeding roller 51. The configuration of the second preferred embodiment further suppresses or prevents the deterioration of the feeding accuracy for a sheet 92.

In the second preferred embodiment, the wire spring 206 preferably is a biasing member that biases the lower feeding roller 51 as described above. As a result, the simply configured wire spring 206 easily biases the lower feeding roller 51. Furthermore, the wire spring 206 and the lower feeding roller 51 are in point contact with each other, making it possible to suppress deformation of the lower feeding roller 51 with a low frictional force. Thus, it is possible to suppress or prevent an increase in the force required to drive the lower feeding roller 51 caused by the frictional force of the wire spring 206.

The second preferred embodiment shares the same effects as in the first preferred embodiment for the elements and configurations not specified above.

### Third Preferred Embodiment

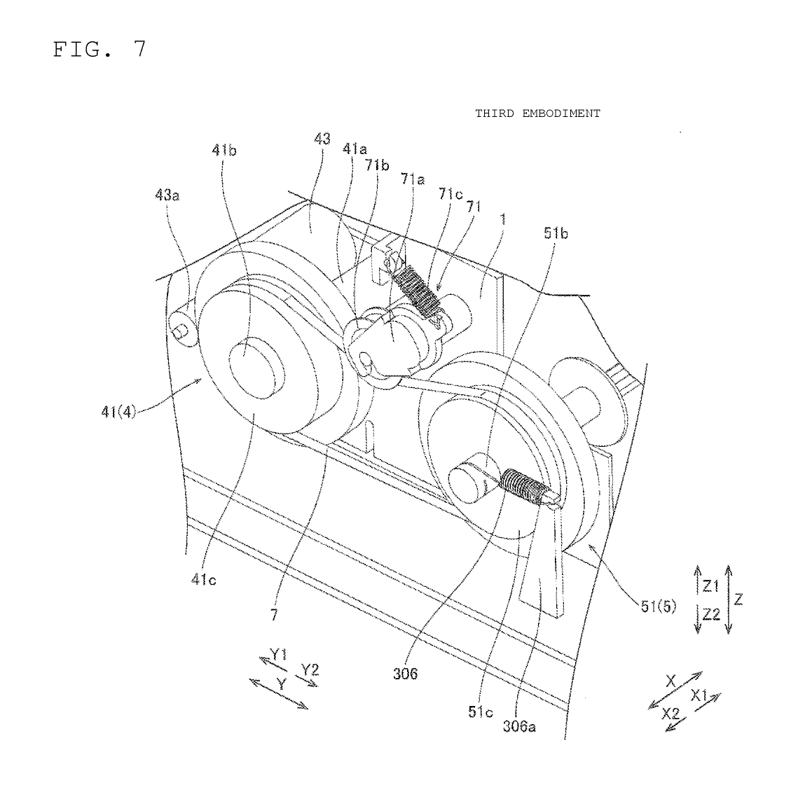

A configuration of an inkjet printer 300 according to a third preferred embodiment of the present invention will be described with reference to FIGS. 1 and 7. The third preferred embodiment describes an example of biasing a lower feeding roller 51 using an extension coil spring 306, unlike the first preferred embodiment that preferably uses the leaf spring 6 to bias the lower feeding roller 51. The inkjet printer 300 is an example of an “image forming apparatus” according to a preferred embodiment of the present invention. The extension coil spring 306 is an example of a “coil spring” and a “biasing member” according to a preferred embodiment of the present invention. For a similar configuration to the first preferred embodiment, description will be omitted by using the same reference signs as in the first preferred embodiment, attached to the figures.

As shown in FIG. 7, the inkjet printer 300 (see FIG. 1) according to the third preferred embodiment includes the extension coil spring 306.

In a housing 1, an extension coil spring mounting unit 306a is arranged on the Y2 direction side of an end of a shaft unit 51b of the lower feeding roller 51. The extension coil spring 306 is arranged so that one end thereof is attached to the extension coil spring mounting unit 306a. The extension coil spring 306 is also arranged so that the other end thereof is attached to the shaft unit 51b from the Y2 direction of the shaft unit 51b.

Thus, with the force that is generated by the extension coil spring 306 and biases the lower feeding roller 51, the resultant moment generated by the extension coil spring 306 with a bearing 51d as a fulcrum is applied to the lower feeding roller 51 counterclockwise as viewed from the Z1 direction.

The third preferred embodiment shares the same configuration as in the first preferred embodiment for the elements and configurations not specified above.

The following effects are achieved in the third preferred embodiment of the present invention.

In a manner similar to the above first preferred embodiment, the third preferred embodiment includes the extension coil spring 306 to bias the lower feeding roller 51 in a direction opposite to the direction of deformation of the lower feeding roller 51 caused by the tension of the second belt 7. The extension coil spring 306 biases the lower feeding roller 51 in the direction opposite to the direction of the deformation of the lower feeding roller 51 caused by the tension of the second belt 7. The lower feeding roller 51 is arranged on the outer side in the axial direction (X direction) of the lower feeding roller 51 with respect to the bearing 51d. The extension coil spring 306 is disposed on the outer side in the axial (X2) direction of the lower feeding roller 51 so as to bias the lower feeding roller 51. The configuration of the third preferred embodiment further suppresses or prevents the deterioration of the feeding accuracy for a sheet 92.

In the third preferred embodiment, the extension coil spring 306 preferably is a biasing member that biases the lower feeding roller 51 as described above. With this configuration, the simply configured extension coil spring 306 easily biases the lower feeding roller 51.

The third preferred embodiment shares the same effects as in the first preferred embodiment for the elements and configurations not specified above.

The preferred embodiments disclosed herein are only examples, not restrictive in all aspects. The scope of the present invention is specified by the scope of claims, not by the descriptions of the preferred embodiments above. Furthermore, all modifications not departing from the scope of claims and the equivalents thereof are included in the scope of the present invention.

For example, applications of various preferred embodiments of the present invention to inkjet printers have been described in the first and second preferred embodiments, but the present invention is not limited to these preferred embodiments. Preferred embodiments of the present invention is also applicable to other image forming apparatuses than an inkjet printer, such as a laser printer.

The first to third preferred embodiments of the present invention have described examples of preferably arranging a second belt on the left end side (X2 direction side). However, the present invention is not limited to this configuration. For example, the second belt may be arranged on the right end side (X1 direction side), according to the present invention.

The first to third preferred embodiments of the present invention have described examples of preferably arranging the second belt to be disposed over a lower sheet supply roller and a lower feeding roller. However, the present invention is not limited to this configuration. For example, the second belt may be arranged over two different feeding rollers in a preferred embodiment of the present invention.

In each of the first, second, and third preferred embodiments of the present invention, a leaf spring, a wire spring, and an extension coil spring have been described, respectively, as examples of a biasing member for the lower feeding roller; however, the present invention is not limited to these configurations. For example, a compressed elastic member such as one made of rubber may be arranged as the biasing member to bias the lower feeding roller in a preferred embodiment of the present invention

The first to third preferred embodiments of the present invention have described examples of preferably arranging the lower feeding roller made of resin. However, the present invention is not limited to this configuration. For example, the lower feeding roller made of metal may be used in a preferred embodiment of the present invention.

The first to third preferred embodiments of the present invention have described examples of preferably arranging the lower sheet supply roller made of metal. However, the present invention is not limited to this configuration. For example, the lower sheet supply roller made of resin may be used in a preferred embodiment of the present invention.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An image forming apparatus comprising:
a printer;
a feeding roller configured to feed a sheet;
a bearing configured to rotatably support the feeding roller with respect to a housing;
a belt rotating mechanism including a belt that is disposed over the feeding roller and drives the feeding roller; and
a biasing member configured to bias the feeding roller in a direction opposite to a direction of deformation of the feeding roller caused by a tension of the belt.

2. The image forming apparatus according to claim 1, further comprising:
a tension applying member including a rotatable member that presses the belt and is rotatable together with movement of the belt, the tension applying member being configured to apply tension to the belt; wherein
the biasing member is configured to bias the feeding roller in a direction opposite to a direction of deformation of the feeding roller caused by the tension applied to the belt by the tension applying member.

3. The image forming apparatus according to claim 1, wherein
the feeding roller is made of resin and integrally includes:
a roller configured to abut the sheet; and
a shaft provided at each end of the roller unit and biased by the biasing member.

4. The image forming apparatus according to claim 1, wherein
the belt rotating mechanism includes a sheet supply roller configured to supply a sheet from the upstream of the feeding roller, the belt being disposed across the sheet supply roller and the feeding roller;
the sheet supply roller is made of metal and has a larger diameter than the feeding roller; and
the biasing member is configured to bias the feeding roller without biasing the sheet supply roller.

5. The image forming apparatus according to claim 1, wherein the biasing member includes one of a leaf spring and a coil spring.

6. The image forming apparatus according to claim 1, wherein the biasing member includes a wire spring.

7. The image forming apparatus according to claim 1, wherein the image forming apparatus is one of an inkjet printer and a laser printer.

8. The image forming apparatus according to claim 1, wherein the feeding roller is configured to receive a combined force from the belt that deforms the feeding roller.

9. The image forming apparatus according to claim 1, wherein a first moment applied by the belt with the bearing as a fulcrum is applied to the feeding roller.

10. The image forming apparatus according to claim 9, wherein a second moment applied by the biasing member with the bearing as a fulcrum is applied to the feeding roller in a direction opposite to a direction in which the first moment is applied.

11. The image forming apparatus according to claim 10, wherein the first moment and the second moment are equal or substantially equal.

12. The image forming apparatus according to claim 5, wherein the leaf spring is L-shaped or substantially L-shaped.

13. The image forming apparatus according to claim 5, wherein the leaf spring includes two flat plate portions.

14. The image forming apparatus according to claim 3, wherein one end of the biasing member is attached to the shaft and another end of the biasing member is attached to the housing.

15. The image forming apparatus according to claim 3, further comprising a coil spring mounting unit located at an end of the shaft.

16. The image forming apparatus according to claim 15, wherein the biasing member is a coil spring connected to the coil spring mounting unit.
